(19) United States
(12) Patent Application Publication
(10) Pub. No.: US 2023/0001429 A1
(43) Pub. Date: Jan. 5, 2023

(54) SCREW HUB, CENTRIFUGE SCREW AND SOLID BOWL SCREW CENTRIFUGE

(71) Applicant: FLOTTWEG SE, Vilsbiburg (DE)

(72) Inventors: Michael Beywl, Bodenkirchen (DE); Michael Nettinger, Landshut (DE); Michael Kraxenberger, Vilsbiburg (DE); Karl-Heinz Grebisz, Detmold (DE)

(21) Appl. No.: 17/781,762

(22) PCT Filed: Dec. 17, 2020
(86) PCT No.: PCT/EP2020/086633

§ 371 Date: Jun. 2, 2022

(30) Foreign Application Priority Data
Dec. 19, 2019 (DE) 102019135215.0
Dec. 19, 2019 (DE) 102019135226.6
Nov. 9, 2020 (DE) 102020129478.6

(51) Int. Cl. B04B 1/20

(52) U.S. Cl. CPC B04B 1/20; B04B 2001/2058

(57) ABSTRACT

The present invention relates to a screw hub (70) for a centrifuge screw which extends along a longitudinal axis and has at least one longitudinal portion (72) having an opening structure (74), wherein the opening structure (74) is formed by a plurality of connecting elements (75) which delimit a plurality of openings (77) for the passage of a medium, in particular a two-phase mixture, wherein the connecting elements (75) are arranged radially outside on the longitudinal portion (72) relative to the longitudinal axis and form a periphery of the longitudinal portion (72), two connecting elements (75) in each case forming a connecting piece pair (81) that delimits at least one opening (77), both connecting elements (75) of the connecting piece pair (81) extending in the longitudinal direction and crosswise to the longitudinal direction, or a first connecting element of the connecting piece pair (81) extending in the longitudinal direction and a second connecting element of the connecting piece pair (81) extending crosswise to the longitudinal direction.

The invention relates to a screw hub, a centrifuge screw, and a solid bowl screw centrifuge. A screw hub according to the preamble of claim 1 is known from WO 2016/019944 A1, for example.

Solid bowl screw centrifuges are characterized by a drum having a closed or solid bowl. The drum is rotated at high rotational speed, whereby a multiphase mixture located within the drum can be separated into at least a heavy phase and a light phase. Usually, the heavy phase is a solid phase, which is conveyed out from the drum by means of a screw, i.e., a centrifuge screw. For this purpose, the screw is mounted within the drum to be rotational relative to the drum, and has a screw spiral coil. The screw spiral coil is arranged around a screw hub.

The screw spiral coil strikes or sweeps along the inner side or the inner bowl surface of the drum, and thus conveys the product of the heavy phase to an axial end region of the drum. At the end of the drum, the product of the heavy phase is conveyed out from a discharging cone, for example. The multiphase mixture to be clarified thus is located between the inner side of the drum and the screw hub.

In certain solid bowl screw centrifuges, a large pond depth is aspired, in particular for clarification technological reasons. At the same time, however, the pond depth is restricted by the diameter of the screw hub and resulting buoyancy and deposition effects there of the mixture to be clarified or of the light phase.

From the initially mentioned WO 2016/019944 A1, a solid bowl screw centrifuge having a screw hub is known, which has a cylindrical section with a grid structure. A screw spiral coil is arranged externally to the screw hub. The grid structure is substantially formed of longitudinal bars so that the medium to be clarified can flow through openings between the longitudinal bars into the drum space or separating space. Such a grid structure formed only of longitudinal bars disadvantageously has insufficient torsional rigidity. Furthermore, high centrifugal forces act upon the longitudinal bars during operation so that the operating behaviour of the screw hub is negatively impacted. In addition, the longitudinal bars only provide a small area at their outside so as to weld the screw spiral coil to the grid structure.

For increasing the rigidity of the screw hub according to WO 2016/019944 A1, reinforcements in the form of oblique struts are employed inside the cylindrical section. The oblique struts can only be installed at high adjusting and welding expenditure, whereby the total costs associated with the production of the screw hub are increased. Since the oblique struts are arranged inside the cylindrical section, the screw hub furthermore has degraded material utilization.

The invention is therefore based on the task to provide a screw hub for a centrifuge screw, which has increased rigidity and improved flow properties and can be manufactured in a simplified manner due to an improved constructional structure. Furthermore, the invention is based on the task to propose a centrifuge screw and a solid bowl screw centrifuge.

According to the invention, this task is solved with respect to the screw hub by the subject matter of claim 1 or 15. With respect to the centrifuge screw and the solid bowl screw centrifuge, the task mentioned above is in each case solved by the subject matter of claim 17 (centrifuge screw) and of claim 18 (solid bowl screw centrifuge). The subclaims comprise at least appropriate configurations and further developments.

Specifically, the task is solved by a screw hub for a centrifuge screw, which extends along a longitudinal axis and has at least one longitudinal portion having an opening structure. The opening structure is formed by a plurality of strut elements or struts, which delimit a plurality of openings for the passage of a medium. The struts are arranged radially outside on the longitudinal portion relative to the longitudinal axis and define a circumference of the longitudinal portion. Two struts form in each case a strut pair that delimits at least one opening, both struts of the strut pair extending in the longitudinal direction and transversely to the longitudinal direction, or a first strut of the strut pair extending in the longitudinal direction and a second strut of the strut pair extending transversely to the longitudinal direction.

The medium may be a two-phase mixture or a three-phase mixture, for example.

The opening structure may also be referred to as an open wall structure. The notions “opening structure” and/or “open wall structure” are meant to illustrate that in the longitudinal portion of the screw hub, the wall structure has a high number of openings and/or a large opening surface in total.

As a strut, a volume body is to be understood substantially extending along a body-related longitudinal axis or a longitudinal axis of a strut.

In a variant according to the invention of the screw hub, both struts of the strut pair extend in the longitudinal direction and transversely to the longitudinal direction. In other words, both struts of the strut pair extend obliquely, in particular angularly in relation to the longitudinal direction. The respective strut is thus arranged such that the longitudinal axis of the strut runs at a defined angle to the longitudinal direction of the screw hub. In other words, the struts do not run in parallel to the longitudinal axis of the screw hub in this variant.

In a further, in particular alternative variant according to the invention of the screw hub, a first one of the two struts extends in the longitudinal direction, and a second one of the two struts extends transversely to the longitudinal direction. In other words, the first strut extends substantially in parallel to the longitudinal axis of the screw hub, and the second strut extends transversely to the longitudinal axis of the screw hub. The second strut may be arranged in this case obliquely, in particular angularly relative to the longitudinal direction. The second strut runs at a defined angle to the longitudinal direction of the screw hub. In this further variant, the second strut does not run in parallel to the longitudinal axis of the screw hub. It is possible for the second strut to extend rectangularly, in particular orthogonally to the longitudinal axis of the screw hub in the circumferential direction.

The longitudinal portion may be substantially cylindrical. The two struts of the strut pair may be converging or diverging in the longitudinal direction. The opening structure is formed of a plurality of struts. In other words, the opening structure is formed of a plurality of strut pairs. The struts of the strut pairs may form the circumference over the entire strut length. Preferably, the struts extend only in the circumferential region of the longitudinal portion. Thereby, an inner space of the longitudinal portion is kept free from disturbing objects, whereby the flow properties in the area of the longitudinal portion and in particular in the area of an inflow zone for the medium to be clarified are improved.

Within the scope of the invention, the longitudinal direction corresponds to a direction in parallel to the longitudinal axis of the screw hub. Under the direction transversely to the longitudinal direction or the transverse direction, a direction along the circumference of the longitudinal portion transversely to the longitudinal axis of the screw hub is to be understood.

The invention has various advantages. Since the opening structure of the longitudinal portion is formed according to the invention of a plurality of struts and has a plurality of openings, a large pond depth can be formed in an associated solid bowl screw centrifuge.

Due to the longitudinal and/or transverse extension of the struts of the opening structure, the longitudinal portion and thus the screw hub have an increased torsional and flexural rigidity. This is particularly advantageous when the screw hub is employed in a solid bowl screw centrifuge having great longitudinal extension since the entire system thereby has increased rigidity.

Furthermore, the screw hub according to the invention can be realized with an enlarged length/diameter ratio due to the high rigidity of the opening structure, since imbalances occurring, in particular in a two-rotor system have less effects upon the operating behaviour and thus on machine vibrations due to the increased rigidity of the entire system. In addition, the screw hub according to the invention has high stability during operation when forces occur due to the buoyancy and deposition effect of the medium to be clarified.

Furthermore, possible reinforcement elements or oblique struts inside the longitudinal portion are cancelled due to the extension of the struts in the longitudinal direction and/or in the transverse direction. The screw hub has a reduced weight, whereby the load of centrifugal force is reduced during operation. Furthermore, the screw hub is of simplified production, since complex aligning and welding of the reinforcement elements is omitted. This has the further advantage that distortion, for example, by the welding process, as well as inner material and component tensions are reduced in producing the screw hub. Manufacturing tolerances can thereby be complied with at low expenditure. Furthermore, the operating behaviour of the screw hub is improved in an advantageous manner.

Due to reinforcement elements being cancelled, unimpeded entering or immerging of the medium into the pond is enabled, in particular in the region of an inlet zone of the medium. The screw hub according to the invention thus has improved flow properties. In general, it is possible for the longitudinal portion having the opening structure to immerge at least partially into the medium, in particular into the pond, during operation. Alternatively. The longitudinal portion of the screw hub may also be located outside the pond during operation. In other words, the longitudinal portion of the screw hub cannot immerge into the pond.

The opening structure of the longitudinal portion is optimized according to the invention in that, due to the position of the struts or strut pairs in the circumferential region of the longitudinal portion, the highest possible proportion of the opening structure cross-section is at maximum spaced from the longitudinal axis forming the axis of rotation of the screw hub. Especially in the region of the longitudinal portion, the screw hub has a high geometrical moment of inertia.

The invention has the further advantage that the struts arranged radially outside form a circumferential, in particular subdivided support area for a screw spiral coil. Thereby, connecting of the screw-spiral coil to the struts or the opening structure is enabled by welding, for example.

In a preferred embodiment of the invention, the struts of the strut pair enclose the opening partially or completely. In other words, the struts of the strut pair delimit the opening partially or completely. The struts together may form a contour of the strut pair that is open towards a side of the strut pair. Preferably, the two struts form a contour of the strut pair that is closed in itself. This has the advantage that the single strut pairs and thus the entire longitudinal portion of the screw hub have increased torsional and flexural rigidity.

Preferably, the opening is formed between the two struts. Alternatively, or additionally, one strut of two adjacent strut pairs may respectively delimit an intermediate opening partially or completely. In other words, both within the strut pair and in each case between two strut pairs, an opening for the medium may be formed.

In a further preferred embodiment of the invention, the struts of the strut pair are formed to be separated from one another or to be in one piece with one another. The struts may also be formed as single elements. In this case, the struts each may be formed by one single rod. As an alternative, the strut pair may be formed of one piece. The struts may be produced in one casting process. In other words, the struts of the strut pair are bonded together in the form of a substance fit. The strut pair may be formed in one piece by precision casting. Alternatively, the struts of the strut pair may also be bonded together in one piece by welding. Due to the separated design of the strut pair, a plurality of different shapes and strut pair geometries can be realized. This increases a diversity of variants when the screw hub is formed. The one-piece design of the strut pair has the special advantage that an increased rigidity of the strut pair results from the contour being closed in itself.

Preferably, the struts are arranged such that the strut pair is formed in the shape of a triangle. In other words, the struts of the strut pair can form a triangle. The triangle can be open or closed. More specifically, the triangle can enclose the opening partially or completely. The triangle can thus have an open contour or a closed contour. It is possible for the struts to be alternatively arranged such that the strut pair has a trapezoidal shape. In general, the strut pair may also be formed to be at least partially circular, in particular arcuate.

In a preferred embodiment of the invention, the strut pair comprises an inner side and an outer side each having a radius towards the opening, wherein the radius of the inner side is greater than the radius of the outer side. In other words, the strut pair can be rounded at the outer side and the inner side towards the opening, wherein the curve at the inner side has a greater radius than the curve of the outer side. The opening is in this case formed between the two struts of the strut pair. Due to the great radius at the inner side of the strut pair, passage of the medium is facilitated in an advantageous manner so that a deposition of the medium or the mixture, for example, the two-phase mixture or the three-phase mixture, is reduced during operation.

The inner side of the strut pair is facing the longitudinal axis of the screw hub or the interior of the longitudinal portion. The outer side of the strut pair is facing away from the longitudinal axis or the interior of the longitudinal portion. In other words, the outer side of the strut pair is facing the inner side of the drum in the installed state of the screw hub.

In a further preferred embodiment of the invention, the strut pair has in each case a surface at the inner side and at the outer side, wherein the surface at the outer side is greater than the surface at the inner side. Specifically, in each case one strut has a surface at the inner side and/or the outer side. The surface of the outer side preferably forms a part of the circumference, for example, for contacting a screw spiral coil. The great surface of the outer side has the advantage that an area as large as possible is made available for fixing a screw spiral coil. In particular, a screw spiral coil is thereby allowed to be welded to the strut pair or the plurality of strut pairs in a facilitated manner.

Preferably, the inner side and/or the outer side of the strut pair are/is formed to be arched, in particular curved, and/or flat. The strut pair may be formed to be arched to the inside and/or arched to the outside. In other words, the inner side and/or the outer side of the strut pair may be formed to be convex. Preferably, the strut pair at the outer side is arched towards the outside. Particularly preferred, the strut pair is arched towards the outside such that a screw spiral coil can two-dimensionally rest at the surface of the outer side. Alternatively, or additionally, the strut pair can be formed to be flat at the inner side and/or at the outer side. In this case, it is advantageous that a constant resting surface as large as possible is provided for an improved contact of a screw spiral coil or screw blades.

Further preferred, the strut pair has at least two front-side connecting areas bonded together by struts in the form of a substance fit. The front-side connecting areas connect the two struts of the strut pair together at their respective ends. The connecting areas may be a part of the struts, i.e., formed in one piece with them. Advantageously, this results in a contour of the strut pair which is closed in itself and encloses the opening.

The front-side connecting areas may be arranged opposite one another in the longitudinal direction. The connecting areas may be formed to have different sizes. In particular in the design of the strut pair as a triangle, a first connecting area connects the struts at the sharp end of the triangle, and a second connecting area connects the struts at the diverging, in particular broad end of the triangle.

In a preferred embodiment of the invention, the connecting areas each have at least one passage opening, by means of which the strut pair is connected to at least one hub element, in particular a transverse disc, a bearing bush or a screw cone, or a further strut pair. The passage opening can be a bore. Preferably, the first connecting area has a single passage opening and/or the second connecting area has at least two passage openings. In order to form the opening structure of the longitudinal portion, the strut pairs can be connected by the passage openings in an easy manner.

The strut pairs can be bonded to the hub element, in particular a transverse disc, a bearing bush or a screw cone, or the further strut pair in a substance-fit and/or force-fit manner. Specifically, the strut pairs can be bonded to the hub element, in particular a transverse disc, a bearing bush or a screw cone, or the further strut pair by welding and/or screwing. In the substance-fit bonding of the strut pairs, in particular by screwing, to a hub element or a further strut pair, the respective strut pair can, for example, due to wear, be easily and rapidly detached and thus exchanged. Further, such a bonding of the strut pairs enables the opening structure to be of modular construction, whereby the screw hub can be fabricated easily in different constructional sizes and constructional lengths, respectively.

The strut pairs may be provided with a wear protection. In this case, at least one metallic layer can be arranged within the strut pairs at least in some portions. By way of example, the metallic layer can be welded to the respective strut pair, in particular to the inner side and/or outer side. A lifetime of the single strut pairs and thus of the screw hub is increased advantageously.

Preferably, the struts of the strut pair each have a cross-section between the two connecting areas, which is substantially constant in the longitudinal direction or along the longitudinal axis of the struts. In other words, the single struts have an unchanged, in particular equal cross-section over the length thereof between the two connecting areas. The cross-section of the struts may be formed to be of a circle form, in particular circular, oval and/or elliptical and/or angular, in particular in a triangular shape, rectangular shape and/or in an X-shape. Other not mentioned cross-sections of the connection elements are possible. The cross-section of the struts is formed in consideration of a high required rigidity, at a material use as low as possible.

In an embodiment of the invention, the longitudinal portion has at least one strut segment formed by several strut pairs interconnected in the longitudinal direction of the screw hub and/or transversely to the longitudinal direction. Preferably, the strut pairs of the strut segment are arranged to be evenly distributed in the circumferential direction. The strut pairs, for example, can be alternatingly arranged, for example, turned by 180 degrees in the circumferential direction. The strut pairs are in this case spaced from one another.

The strut segment may be formed to be ring-shaped or elongated in the axial direction. The strut pairs can be bonded together in the circumferential direction by single connecting bridges. It is possible for adjacent strut pairs to be bonded together directly or indirectly in the longitudinal direction and/or in the transverse direction. By forming strut segments, the screw hub can be constructed to be arbitrarily modular. Thereby, a variant variety of the screw hub is decisively increased.

In a preferred embodiment of the invention, the longitudinal portion has several strut segments arranged along the longitudinal axis and connected to one another by intermediate transverse discs, wherein the strut pairs of the strut segments are coupled to the transverse discs. The strut pairs of two adjacent strut segments may be arranged to be oppositely alternating, in particular be turned alternatingly. The transverse discs may be formed to be closed, in particular free from passage openings, or open and having a concentric bore, respectively. Due to the transverse discs, the strut pairs are axially supported.

In general, the screw hub according to the invention may have, in addition to the longitudinal portion, a solid matter discharge side portion, which is formed, for example, as a conical portion, and a bearing portion. The longitudinal portion is in this case arranged between the solid matter discharge side portion and the bearing portion. All of the three portions are situated on a common longitudinal axis, which also forms the axis of rotation of the screw hub. In order to connect the single strut segments to one another, the transverse discs are arranged between the strut segments. The single strut pairs may in this case be frontally connected, in particular by the respective connecting area, to the associated transverse disc in a substance-fit and/or force-fit manner. Due to the construction of the longitudinal portion by means of strut segments, a modular construction of the screw hub is enabled and the variant diversity is increased as described before. In the event of signs of wear, such strut segments furthermore can be easily and rapidly replaced.

A subordinate aspect of the invention is related to a screw hub for a centrifuge screw extending along a longitudinal axis and having at least one longitudinal portion formed by a tube, wherein within the tube, in particular within the tube wall, a plurality of openings for the passage of a medium is formed. The openings each have a longitudinal extension, which is preferably greater than the width of the respective opening.

In comparison to the initially mentioned WO 2016/019944 A1, the screw hub according to the further aspect has the advantage that it can be easily and cost-efficiently produced. The openings within the tube wall may substantially be formed by mechanical processing. Alternatively, the openings may be formed by laser cutting. In this case, it is advantageous for a welding effort to be considerably reduced during production and the screw hub has high stability. Furthermore, based on this embodiment of a screw hub, a large and continuous resting surface for a screw spiral coil, for example, is provided. Thereby, an automation of subsequent working steps in producing the screw or centrifuge screw is advantageously enabled.

The medium may be, for example, a two-phase mixture or a three-phase mixture.

In an embodiment of the subordinate aspect of the invention, the openings are formed in the circumferential direction to be spirally or helically distributed.

Due to the spiral or helical arrangement of the openings, two spirals or helices are basically formed. A first spiral or helix has the openings spaced from one another. A second spiral or helix is formed between the first spiral or helix and has a full tube material. The second spiral or helix serves in particular as a resting surface and/or fixing surface for the screw spiral coil.

The longitudinal portion may be formed in one piece. Due to the one-piece design, only low tensions occur. In this case, no or only a small number of welding seams are required advantageously so as to form the longitudinal portion. Thereby, concentricity of the screw hub is improved.

The openings may have a parallelogram-like shape, for example.

It applies for all of the screw hubs according to the invention that the described longitudinal portion may concern the complete cylindrical longitudinal portion of the screw hub or only a portion of the cylindrical longitudinal portion.

It is possible, for example, that the described longitudinal portion having the described opening structure is formed between two further longitudinal portions having a closed wall structure. It is likewise possible that the described longitudinal portion having the described opening structure is formed between a portion having a closed wall structure and a solid matter discharge side portion of the screw hub.

A further subordinate aspect of the invention is related to a centrifuge screw having a screw hub according to the invention and a screw spiral coil arranged at the screw hub to be circumferential.

A further subordinate aspect of the invention is related to a solid bowl screw centrifuge having a centrifuge screw of the kind mentioned above and/or a screw hub according to the invention.

With respect to the centrifuge screw and the solid bowl screw centrifuge, reference is made to the advantages explained in conjunction with the screw hub. Furthermore, the centrifuge screw and/or the solid bowl screw centrifuge may have alternatively or additionally single features or a combination of several features mentioned above with respect to the screw hub.

It is possible for the screw hub according to the invention and/or the centrifuge screw according to the invention to have a further developed inlet region. An inlet tube, which has an inlet tube opening, opens into the inlet region, wherein opposite the inlet tube opening, an impact element, in particular an impact disc, having an acceleration element is formed. The acceleration element is formed such that a medium impinging on the acceleration element can be accelerated in the direction of openings of the screw hub. The openings are in this case the openings formed due to the opening structure.

Since the screw hub has according to the invention at least in some sections a longitudinal portion having an opening structure, a large pond depth can be formed in an associated solid bowl screw centrifuge. Since the inlet region is not formed as in the classical sense as an inlet chamber having corresponding massive and mostly closed walls, but is itself formed by an opening structure of the screw hub, for instance, the openings of the screw hub can serve themselves as the openings of the inlet region.

In other words, the inlet region of a centrifuge screw comprises at least in some sections an inlet tube, wherein at least the portion of the inlet tube, which has an inlet tube opening, is formed as an integral part of the inlet region of the centrifuge screw. The impact element preferably is formed as an impact disc. Such an impact disc may also be designated as a closing disc. Due to the acceleration element formed on the impact element, pre-acceleration of the medium to be processed can be performed.

The acceleration element preferably has impact surfaces positioned obliquely to the axis of rotation. Due to the formed acceleration element, the medium impinging on the impact element or the acceleration element can be carefully pre-accelerated relatively free from turbulences.

The surrounding geometry having the openings structure of the screw hub or the openings of the screw hub and an open liquid surface, may anyway receive the medium in the longitudinal and circumferential direction more carefully than a tube construction having only sporadic inlet openings. With inserting an acceleration element, however, the speed difference when the medium is impinging, is again reduced in a positive manner.

The acceleration takes place in the direction of the openings of the screw hub. Only then, the medium gets into the drum interior or separating space via the free spaces when the screw hub is rotating.

Occurring turbulences known from the state of the art in conjunction with the medium flow flowing into an inlet chamber and subsequently getting into the drum interior can be damped according to the invention and energy losses be reduced.

The massive walls known from inlet chambers formed in a standard way, are omitted in the inlet region according to the invention and are rather formed by longitudinal bars and/or strut elements and/or openings and/or material recesses, for example.

Apart from the improved pre-acceleration of the medium to be processed, the inlet region according to the invention promotes additives to be better mixed in. These additives may be, for example, precipitants or flocculants.

The size or the passage surface of the openings is preferably determined based on the distances formed between the strut elements or the opening edges. In a further embodiment of the invention, the size or the passage surface of the free spaces is formed by the size and the shape of longitudinal slots of the screw hub.

The acceleration element substantially is formed as a protrusion pointing in the direction of the inlet tube opening. It is possible for the protrusion to be arranged on a disc or plate. The disc or plate may be of a flat or arcuate design.

Together with the disc or plate, the protrusion may form an autonomous component which can be produced separately from the impact element, in particular the impact disc. This facilitates retrofitting an impact element with the acceleration element, for example.

In a further embodiment of the invention, it is possible for the protrusion to be directly fixed on the impact element, in particular the impact disc. This enables material to be saved.

In an embodiment of the invention, the acceleration element has struts which are in particular arranged in a cross-shape relative to one another. It is also conceivable for several struts to form a star-shape in a top view of the acceleration element. In such an embodiment of the invention, the protrusion is formed by an arrangement of struts.

In an embodiment of the invention, it is possible for the height of the struts to increase in the direction of a point of intersection of the struts. As the height of the struts, the relative distance from the impact element, in particular the impact disc, or—if formed—the relative distance from the separate disc or plate is understood.

Preferably, the acceleration element is arranged on the impact element such that a point of intersection and/or a highest point of the acceleration element are/is formed to be aligned to the center point of the impact element, in particular the impact disc. In other words, the point of intersection and/or the highest point of the acceleration element is arranged on the longitudinal axis of the centrifuge screw.

In a further or alternative embodiment of the invention, the acceleration element may be formed as a protrusion protruding from the impact element and pointing in the direction of the inlet tube opening. This protrusion has several radial flanks. Radial flanks are to be understood to be such flanks running in the direction of the impact element starting from a centrally arranged central point. Preferably, the radial flanks are arranged uniformly or evenly spaced from one another in the circumferential direction.

It is furthermore possible for channels to be formed between the flanks, wherein the channels can have a swirling course. If a medium impinges upon such an acceleration element, the medium will be deviated and accelerated along the channels in the direction of the impact element and in the direction of the free spaces. In other words, the channels and/or flanks are evenly distributed across the protrusion.

It is possible for the acceleration element to be formed as a protrusion protruding from the impact element and pointing in the direction of the inlet tube opening, and which has several, for example four, impact surfaces arranged obliquely to the longitudinal axis of the inlet region. The longitudinal axis of the inlet region is in particular the axis of rotation of the centrifuge screw.

The impact surfaces may be arranged relative to one another, for example, in such a manner that the protrusion has a pyramid shape. The pyramid tip may in particular be formed to be flattened.

In a further embodiment of the invention, several oblique struts stabilizing the screw hub are attached to the impact element, in particular the impact disc. An end of the stabilizing oblique struts may be formed on the impact element. The further end may be attached, for example, to a further transverse disc of the centrifuge screw or to an end disc of a centrifuge screw.

In a further embodiment of the invention, the screw hub according to the invention and/or the centrifuge screw according to the invention may have a further developed transverse disc.

A transverse disc of this kind is formed such that at least one opening is formed at least in some sections on at least 75% of all the imaginary circle lines of the transverse disc from the center point to the transverse disc circumference. The imaginary circle lines are all of those circle lines that can be formed in the radial extension between the center point and the transverse disc circumference.

Preferably, only a distance of 5 mm, in particular of 2 mm, in particular of 1 mm, in particular of 0.5 mm between the circle lines is formed in the theoretical or imaginary formation. In such an observation of the circle lines, the distance between the circle lines preferably is formed to be of equal size.

As a transverse disc of a centrifuge screw, such a disc is to be understood, which is formed transversely to the longitudinal axis of the screw hub. The transverse disc serves for stabilizing a screw hub, which has an opening structure or a plurality of openings. A transverse disc may also be designated as a support disc.

Starting from the center point in the direction of the disc circumference, the transverse disc has imaginary circle lines. An opening or a section of an opening is formed at least in some sections on at least 75% of all of the imaginary circle lines.

In other words, in at least 75% of the entire diameter area of the transverse disc, at least one opening or at least one partial section of an opening is formed at least in some sections across the respective diameter. In other words, on at least 75% of all of the diameters of the transverse disc, at least one opening or at least one partial section of an opening is formed in at least some sections across the respective diameter.

In a further embodiment of the invention, in at least 85% of the entire diameter area of the transverse disc, at least one opening or at least one partial section of an opening is formed at least in some sections across the respective diameter. In other words, on at least 85% of all of the diameters of the transverse disc, at least one opening or at least one partial section of an opening is formed in at least some sections across the respective diameter.

In a further embodiment of the invention, in at least 90% of the entire diameter area of the transverse disc, at least one opening or at least one partial section of an opening is formed at least in some sections across the respective diameter. In other words, on at least 90% of all of the diameters of the transverse disc, at least one opening or at least one partial section of an opening is formed in at least some sections across the respective diameter.

In a further embodiment of the invention, at least one opening or at least one partial section of an opening is formed across the entire diameter area of the transverse disc at least in some sections across the respective diameter. In other words, at least one opening or at least one partial section of an opening is formed on all of the diameters of the transverse disc at least in some sections across the respective diameter.

Such a formation of openings across a large part of the diameter area of the transverse disc enables the liquid or the centrate within the region of the screw hubs to flow off well. At the same time, such a transverse disc has sufficient rigidity so that the transverse disc continues also to cause the screw hub to be well stabilized.

In an embodiment of the invention, in particular a diameter area of the transverse disc delimiting a central middle opening can be formed without opening(s). Such a section free from openings can serve for additionally stabilizing the transverse disc.

In a particularly preferred embodiment of the invention, an opening or a section of an opening is formed on all imaginary circle lines of the transverse disc at least in some sections. In other words, across the entire diameter area of the transverse disc, at least one opening or at least one partial section of an opening is formed with respect to each diameter in a particularly preferred manner.

It is possible for the transverse disc to be constructed such that across the entire diameter area of the transverse disc, the liquid or the centrate is enabled to flow off.

Preferably, the openings of the transverse disc are formed such that these openings have different geometries and/or opening sizes and/or arrangement patterns.

As the geometry of an opening, the shape of the opening is to be understood. It is possible for the transverse disc to have several openings having different geometries.

The opening size of an opening concerns in other words the opening surface. Through the opening size, the liquid can flow through and/or off. It is possible for the openings to have different dimensions with respect to the opening sizes.

As the arrangement pattern, the arrangement of several openings is to be understood, wherein at least two openings form a group of openings, wherein several groups of openings can be arranged to be distributed over the transverse disc. Furthermore, it is possible for the transverse disc to have a group of openings, which form several openings evenly distributed across the transverse disc. Preferably, a group of openings is formed by several identically formed openings. As identical openings, openings are to be understood, which have the same geometry and the same cross-sectional surface.

In an embodiment of the invention, the transverse disc has several openings formed in a cam shape or an oval shape or elliptically. Preferably, such openings are arranged in pairs. A pair of such openings thus forms a group of openings. Several of such groups of openings, however, can be evenly be distributed across the transverse disc.

As a cam-shaped opening, such an opening is to be understood which substantially has the shape, in particular the cross-sectional shape, of a cam of a camshaft. Such an opening has in particular the shape of a steep cam. In other words, such an opening is formed by two circle segments, the central radius points of which are on a common mirror axis of the opening. The circle segments are in turn connected to one another in some sections by straight lines.

It is furthermore possible for the openings to be formed in an oval shape or elliptically. In a particularly preferred embodiment of the invention, two such openings are respectively arranged relative to one another such that they form a group of openings.

In a particularly preferred embodiment of the invention, six openings are respectively formed in a cam shape or oval shape or elliptically, wherein two openings respectively form a group of openings. The three groups of openings thus formed are evenly distributed on the transverse disc in the circumferential direction.

The transverse disc furthermore can have several openings starting from the transverse disc circumference, which are formed as recesses of the transverse disc circumference.

These recesses preferably are formed in a U shape.

Preferably, such recesses, in particular U-shaped recesses are in turn arranged in pairs. In a particularly preferred embodiment, the transverse disc has six of such recesses, in particular six U-shaped recesses of this kind. Two of the recesses form a group of openings. The three groups of openings thus formed are evenly arranged on the transverse disc in the circumferential direction. In the circumferential direction, preferably one group of openings formed of U-shaped recesses respectively alternates with a group of openings formed of cam-shaped recesses.

Preferably, the U-shaped recesses have such a length in the direction of the center point of the transverse disc, that in the radial extension from the center point to the transverse disc circumference, the U-shaped recesses are located at least in some sections on consistent circle lines to the openings formed in a cam shape.

It is furthermore possible for the transverse disc to have several openings formed to be circular.

The openings formed to be circular preferably are arranged in pairs. In other words, two circular openings form a group of openings.

Again preferably, six circularly formed openings are formed. Six of such openings can form three groups of openings having circular forms. The groups of openings in turn are evenly arranged on the transverse disc in the circumferential direction.

It is furthermore possible for circularly formed openings to be arranged as single openings, i.e., not as groups of openings. It is moreover possible for the transverse disc to have different embodiments of circularly formed openings. For example, a first kind of circularly formed openings can be arranged as groups of openings. A second kind of circularly formed openings can respectively be arranged as a single opening.

In a further preferred embodiment of the invention, a group of openings of circular openings and a group of openings formed of U-shaped recesses each are formed in an identical circle segment. The group of openings having circular openings is formed internally in this case, i.e., internally in the direction of the center point.

In a preferred embodiment of the invention, the transverse disc is formed of six circle sectors, wherein three circle sectors each have the groups of openings having cam-shaped openings, and three circle sectors each have respectively one group of openings formed of U-shaped recesses and one group of openings formed of circular openings. The thus formed circle sectors each are formed alternatingly.

At the transverse disc circumference, preferably substantially semicircular recesses can be formed, which are arranged evenly distributed. The in particular semicircular recesses may in particular serve for receiving strut elements forming, for example, the screw hub structure.

Furthermore, it is possible for the recesses formed at the transverse disc circumference to have such a shape that strut elements of the opening structure of the screw hub engage or can engage into the recesses. Furthermore, it is possible for the recesses formed at the transverse disc circumference to have such a shape that tube wall portions of the screw hub can engage into the recesses.

In the center point of the transverse disc, an opening may be moreover formed. The center point opening may have a circular shape having additionally further circle segment-like recesses, in particular three circle segment-like recesses. As a circle segment-like recess such a recess is to be understood, which is formed by one circle segment, wherein the circle segment is the partial surface of a circular surface delimited by a circular arc and a circular chord.

Preferably, the circle segment-like recesses, in particular the three of the circle segment-like recesses are evenly formed in the circumferential direction around the circular shape of the center point opening formed in such a manner.

In a further embodiment of the invention, it is possible for the circle segment-like recesses, in particular the three of the circle-segment-like recesses, to be arranged within the transverse disc in such a manner that in the circumferential direction, in each case one group of openings formed of two circularly formed openings, and one circle segment-like recess of the center point opening are alternating.

Preferably, three groups of openings formed in each case of two circularly formed openings and three circle segment-like recesses are formed. Preferably, it is provided for at least one imaginary circle line of the transverse disc to intersect both the circle segment-like recesses and the groups of openings formed in each case of two circularly formed openings.

In a further embodiment of the invention, the openings may also have a rhombus shape and/or a polygon shape and/or a pointed arc shape and/or a triangle or square shape having at least partially bent sides.

Between the single openings of the transverse disc, the material of the transverse disc is formed. This material is preferably formed of metal.

In a possible embodiment of the invention, the openings have such a size and are arranged with respect to one another such that the material of the transverse disc is formed in a strut-like manner. The struts can be formed in a straight and/or curved shape. When struts are formed, a particularly advantageous relationship of opening sizes in relation to the remaining material of the transverse disc is created.

It is possible for several further developed transverse discs to be formed within the screw hub. Furthermore, it is possible for the transverse discs arranged within a screw hub to be differently formed. It is possible for at least one of the formed transverse discs to be a further developed transverse disc, whereas the further transverse disc(s) has/have another formation. It is in particular possible for different sections of the screw hub to be separated with a closed transverse disc. Preferably, a closed transverse disc is formed within a transition area to the solid matter discharge side of the screw hub.

In a particularly preferred embodiment of the invention, the transverse disc forms an axial passage for a centrate produced within a/the solid bowl screw centrifuge independently of the pond depth formed within the drum of the solid bowl screw centrifuge.

In other words, by means of the solid bowl screw centrifuge according to the invention and/or of the solid bowl screw centrifuge according to the invention, which has/have a further developed transverse disc, it is effectively avoided that the solid matter is accumulated within the drum such that the openings or recesses formed as a standard at the transverse disc circumference are clogged with solid matter.

The liquid/centrate may rather freely flow off due to the design of the transverse disc. According to the invention, an axial passage for the liquid/centrate is enabled at any pond depth without the centrifuge screw losing stability.

In a further embodiment of the invention, the screw hub according to the invention and/or the centrifuge screw according to the invention may have a further developed form at the solid matter discharge side portion. Specifically, the screw hub according to the invention and/or the centrifuge screw according to the invention may have an at least partially closed shape deviating from a simple cone shape.

The solid matter discharge side portion preferably forms at least one end of the screw hub. The solid matter discharge side portion may have an at least partially closed shape deviating from a simple cone shape so as to cause an improved solid matter discharge as well as a correspondingly improved nature of the solid matter discharge in various fields of application or in materials to be differently processed.

As a simple cone shape such a form is to be designated, which has a truncated-cone shape in a longitudinal section through the screw hub. The truncated-cone shape is formed due to the closed shell surface.

It is possible for the solid matter discharge side portion to be formed as a cylinder portion and/or cylindrical tube portion. As such a cylinder portion and/or cylindrical tube portion, in particular such a portion is to be understood, which has a tube, wherein the tube is attached to the cylindrical longitudinal portion, for example, by means of a connecting flange. In the following, such a cylinder portion is designated as a tube, which is formed to be hollow at least in some sections.

With the help of such an implementation of a solid matter discharge side portion of the screw hub, such a screw hub and thus such a centrifuge screw may be provided, which contribute to reduce bottlenecks in the direction of the solid matter discharge in a particularly advantageous matter. Such bottlenecks are known in case of a solid bowl screw centrifuge. These are known to be in the area of the transition from a cylindrical longitudinal portion to a discharge portion.

The drum of a solid bowl screw centrifuge frequently has a cone shape in this portion. By forming a cylinder portion and/or a cylindrical tube portion, an increased volume is provided within the drum in the area of the solid matter discharge or in the area of the last dwelling path of the solid matter to be transported. Thus, a reduction of known bottlenecks is the result. Due to that, high solid matter loads may be transported in a certain temporal specification during the treatment of a material or medium to be separated.

A further advantage in forming the solid matter discharge side portion as a cylinder portion and/or cylindrical tube portion is that the solid matter is present in relaxed form. This applies also to such a solid matter which potentially had already been compressed during treatment. Such a relaxed solid matter cakes less at the solid matter discharge and is present in a free-flowing form. Due to the reduced forces acting upon the solid matter discharge side portion, such an embodiment is particularly low-wear.

Forming a cylindrical tube portion as the solid matter discharge side portion is suitable in processing slurries having a high mineral proportion. The processing of wearing media may also be performed in a particularly careful manner with such an embodiment of the solid matter discharge side portion.

Since the screw hub in addition has a cylindrical longitudinal portion having an open wall structure or an opening structure, the screw hub can immerge into a pond of the mixture to be clarified and revolving within the drum, wherein no disadvantageous effects occur during immerging due to buoyancy forces.

By means of the screw hub according to the invention, a large pond depth may be realized, on the one hand, in conjunction with a solid bowl screw centrifuge, wherein improvements in the area of the solid matter discharge are achieved at the same time.

It is possible for the cylinder portion and/or cylindrical tube portion to be formed stepped such that the cylinder portion and/or cylindrical tube portion has/have at least two portions having different diameters in the longitudinal direction of the screw hub.

By means of such a stepped shape, an improved reduction with respect to the non-desired formation of bottlenecks can be achieved. At the same time, the solid matter to be transported and discharged may further be relaxed.

The at least two portions of the cylinder portion and/or cylindrical tube portion preferably are arranged such that the portion having the smaller or smallest diameter is arranged to be spaced further apart from the cylindrical longitudinal portion than the portion of the cylinder portion and/or cylindrical tube portion having the larger or largest diameter. The step-shaped formation of the cylinder portion and/or cylindrical tube portion is preferably performed such that the diameters of the portions are reduced in a stepwise manner in the direction of the frontal side of the screw hub associated with the solid matter discharge side portion.

In a further embodiment of the invention, it is possible for the solid matter discharge side portion to have a double truncated-cone shape. The double truncated-cone shape preferably is formed such that the imaginary base surfaces of two truncated cones are adjacent to one another.

The double truncated-cone shape preferably is formed such that the largest diameter of the double truncated-cone shape is neither formed at a connecting portion to the cylindrical longitudinal portion nor at the frontal side of the screw hub assigned to the solid matter discharge side portion.

A first cover area of a first truncated cone of the double truncated-cone shape is arranged in a connecting portion and/or a transition area to the cylindrical longitudinal portion of the screw hub.

A second cover area of a second truncated cone of the double truncated-cone shape is arranged at the frontal surface assigned to the solid matter discharge side portion or pointing in the direction of this frontal surface.

It is possible for the truncated cones forming the double truncated-cone shape to have the same height. In such an embodiment of the invention, the double truncated-cone shape is formed to be axially symmetrical. The symmetry axis is formed in the area of the superimposed base surfaces of the two truncated cones.

In a further embodiment of the invention, the truncated cones forming the double truncated-cone shape have different heights. Preferably, the truncated cone formed adjacent to the cylindrical longitudinal portion has a smaller height than the second truncated cone pointing in the direction of the frontal surface of the screw hub.

By means of forming the solid matter discharge side portion in the form of a double truncated-cone, fine matters of materials to be processed and being already separated in terms of phases can be separated better again.

Due to forming the double truncated-cone shape, such centrifuge screws can moreover be formed, which have a lower screw spiral coil height and/or a lower baffle plate height. In this respect, material may consequently be saved in conjunction with the screw spiral coils as well as in conjunction with baffle plates to be formed potentially.

Additionally, the mentioned components of a centrifuge screw or a solid bowl screw centrifuge, namely a screw spiral coil and/or a baffle plate are less heavily loaded than this is the case in conjunction with forming simple cone shapes in the solid matter discharge side portion.

When a screw hub having a double truncated-cone shape is formed in the area of the solid matter discharge side portion, furthermore a calmer and more stable operational behavior of a corresponding solid bowl screw centrifuge is observed.

Due to forming a double truncated-cone shape, the distance between the screw and the drum of the solid bowl screw centrifuge is reduced. This presses the solid matter, for example, against the baffle plate and increases a pressing force. Separated liquid, in particular separated water, may flow off unpressurized along the screw due to this construction.

It should be pointed out that all of the features mentioned in the application documents and in particular in the dependent claims, should be provided with an autonomous protection even singly or in any combination despite the performed formal back-reference to one or several certain claims.

This concerns in particular combinations of the various embodiments of the screw hubs having further constructional details such as transverse discs and/or an inlet region and/or a special shaping of the solid matter discharge side portion of the screw hub.

The invention will be explained in more detail below by means of particulars while referring to the appended drawings. The represented embodiments illustrate examples how the screw hub according to the invention may be configured.

Shown are in:

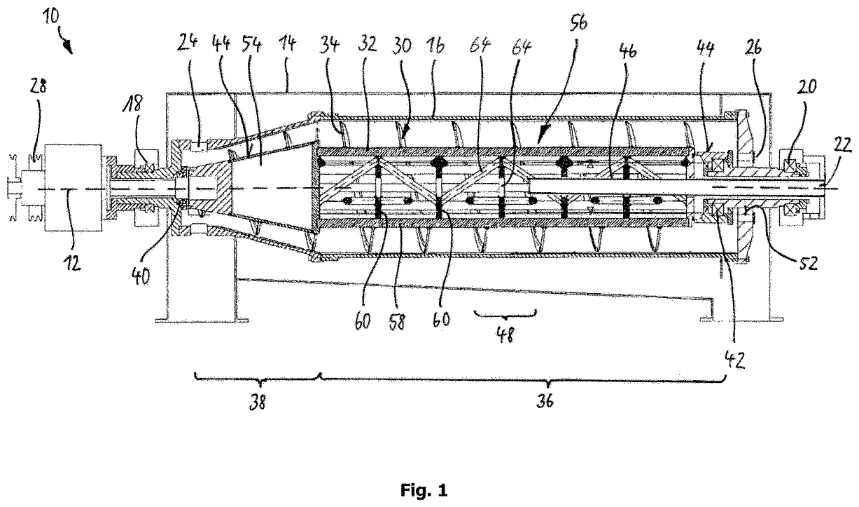

FIG. 1 a longitudinal section of a solid bowl screw centrifuge according to the state of the art;

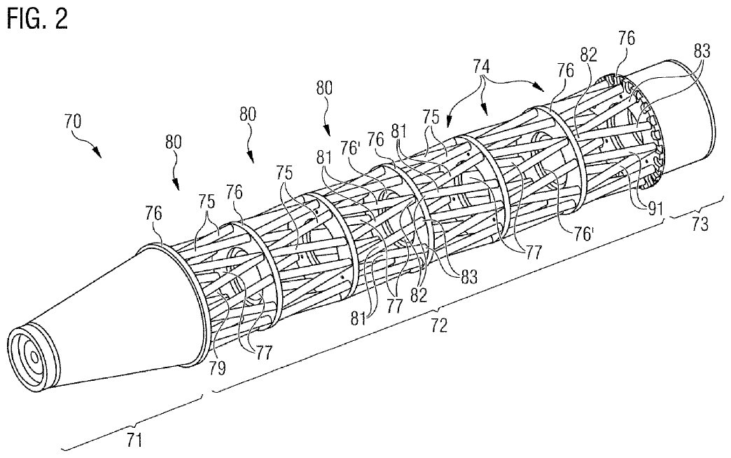

FIG. 2 a perspective view of a screw hub according to an exemplary embodiment according to the invention;

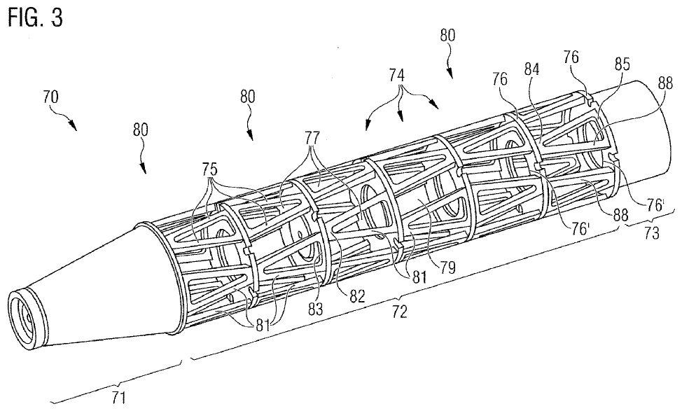

FIG. 3 a perspective view of a screw hub according to a further exemplary embodiment according to the invention;

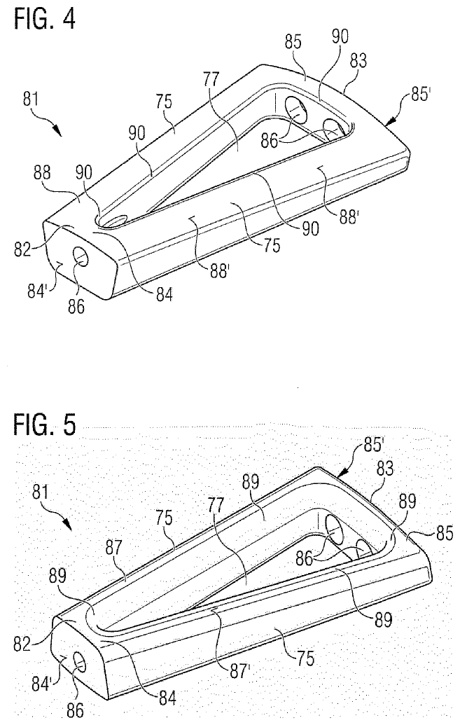

FIG. 4 a perspective top views of one of the strut pairs of the screw hub according to FIG. 3;

FIG. 5 a perspective bottom view of the strut pair according to FIG. 4;

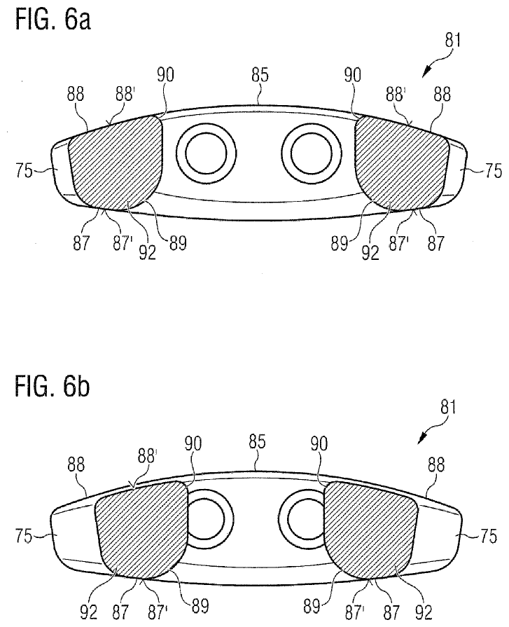

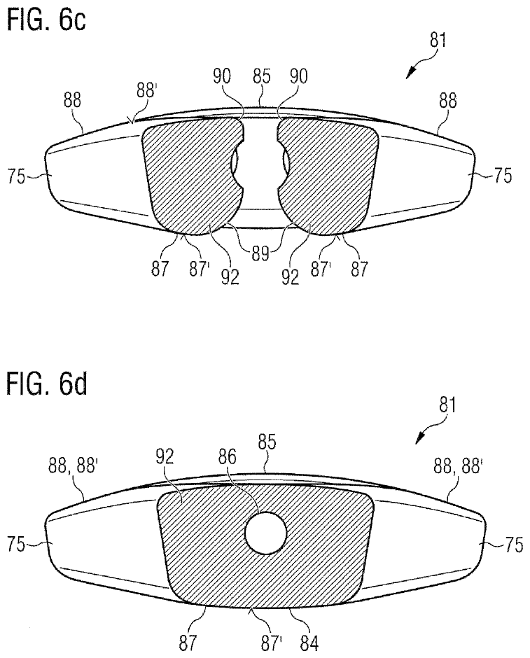

FIGS. 6a-6d several cross-sections of the strut pair according to FIGS. 4 and 5;

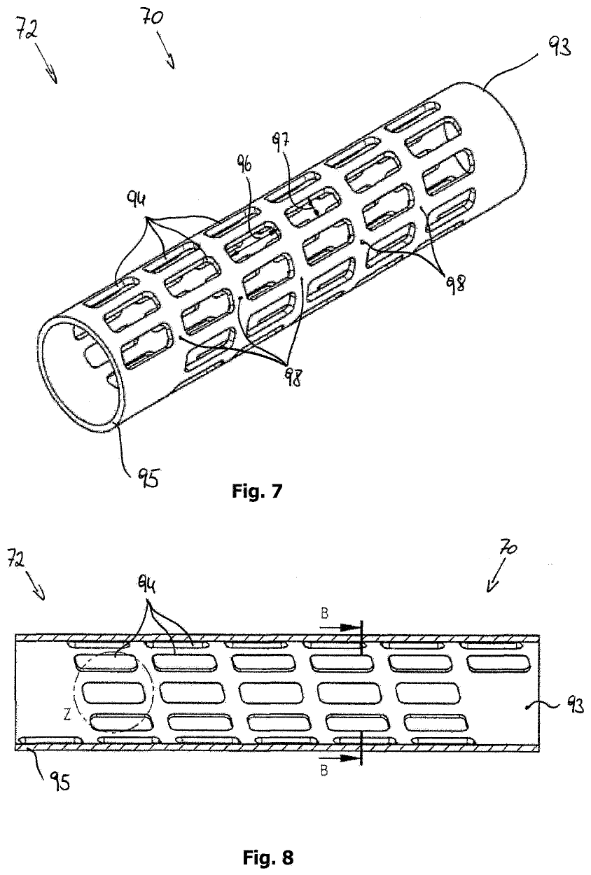

FIG. 7 a perspective view of a longitudinal portion of a screw hub according to a further exemplary embodiment according to the invention;

FIG. 8 a longitudinal section through the longitudinal portion of the screw hub according to FIG. 7;

FIG. 8 a cross-section through the longitudinal portion of the screw hub according to FIGS. 7 and 8; and

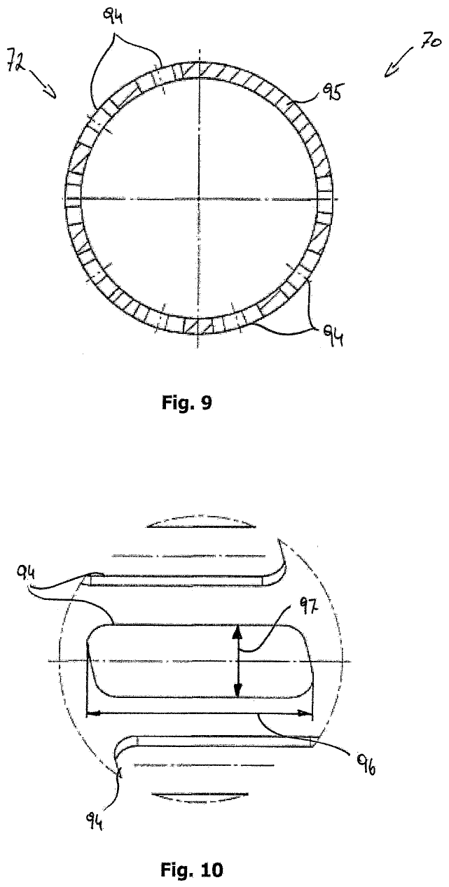

FIG. 9 a detailed view of one of the openings of the longitudinal portion of the screw hub according to FIGS. 7 to 9.

The same reference numerals will be used in the following for identical part and parts of identical action.

In FIG. 1, a solid bowl screw centrifuge 10 according to the state of the art is illustrated. Hereinafter, by means of FIG. 1 as an example, the basic structure as well as the basic function of a solid bowl screw centrifuge 10 will be explained, in which a screw hub 70 according to the invention can be employed. The screw hub 70 will be discussed in more detail later.

The solid bowl screw centrifuge 10 according to FIG. 1 extends substantially along a horizontal longitudinal axis 12 and has an outer housing 14, in which a drum 16 is mounted to be rotatable about the longitudinal axis 12. By rotating the drum 16 at high rotational speed, a centrifugal force can be generated within it, by mans of which a product to be clarified can be separated into a heavy phase and a light phase. For this purpose, the drum 16 is supported on a first drum bearing 18 and a second drum bearing 20.

At the drum 16, an inlet 22 for the product to be clarified, as well as an outlet 24 for the heavy phase and an outlet 26 for the light phase are formed. For rotating the drum 16, a drive 28 is formed.

The outlet 26 acts as an overflow for the light phase located radially inside within the drum, so that it exits autonomously there, if a predetermined level, the so-called pond depth 52 is reached within the drum 16.

So that the heavy phase located radially outside within the drum 16 can be discharged from the drum 16, a centrifuge screw 30 is provided within the drum 16. The centrifuge screw 30 is rotated relative to the drum 16 by means of the drive 28. Thereby, the material of the heavy phase is discharged along a cone shape at the drum 16 towards radially inside and thus to the outlet 24.

For this purpose, the centrifuge screw 30 is configured so as to have a screw hub 32 extending along the longitudinal axis 12 and being surrounded radially outside by a screw spring coil 34. The screw hub 32 thus serves the purpose of supporting the screw spiral coil 34 in the radial direction, of transmitting torque from the drive 28 to the screw spiral coil 34, and in particular of receiving tensional forces and thrust forces on this occasion. The screw hub 32 has a longitudinal portion 36 having a grid structure 56 of longitudinal bars 58, oblique struts 64 and transverse discs 60. The longitudinal portion 36 is formed cylindrically. Across the circumference of the screw hub 32, the longitudinal bars 58 are arranged in the longitudinal direction thereof, thus in parallel to the longitudinal axis 12, to be distributed at even distances.

In the conical portion 38, the screw hub 32 is formed having a shell surface 44. The shell surface 44 is substantially closed and in particular configured by means of a sheet metal or tube surface. The centrifuge screw 30 is mounted to be rotational by means of a first screw bearing 40 and a second screw bearing 42.

In FIG. 1, and inlet tube 46 may furthermore be recognized. Through this inlet tube 46, the medium to be separated gets into the solid bow screw centrifuge 10. The inlet tube 46 serves for supplying a product to be clarified centrally into an inlet region 48 to the interior of the screw hub 32.

According to FIG. 2 and FIG. 3, an screw hub 70 according to an exemplary embodiment according to the invention is shown in each case. The screw hub 70 according to the two exemplary embodiments according to the invention shown in FIG. 2 and FIG. 3 can be employed in the solid bowl screw centrifuge 10 shown in FIG. 1. In this case, the screw hubs 70 replace the screw hub 32 illustrated in FIG. 1. Alternatively, the screw hubs 70 according to FIGS. 2 and 3 can be employed in other solid bowl screw centrifuges that are not illustrated.

The screw hub 70 according to FIGS. 2 and 3 extends along a longitudinal axis and comprises a conical longitudinal portion 71, a cylindrical longitudinal portion 72, and a bearing portion 73. The portions 71, 72, 73 have the longitudinal axis as the common axis. The conical longitudinal portion 71 corresponds to the conical portion 38 of the screw hub 32 according to FIG. 1 described above. The bearing portion 73 serves for receiving a bearing, in particular the screw bearing 42 described above, in order to rotatably mount the screw hub 70. It is possible for the longitudinal portion 71 to have in further embodiments of the invention an at least partially closed shape deviating from the simple cone shape. The longitudinal portion 71 may be formed, for example, as a cylinder portion and/or a cylindrical tube portion. Furthermore, it is possible for the longitudinal portion 71 to have a double truncated-cone shape.

The cylindrical longitudinal portion 72 of the screw hub according to FIGS. 2 and 3 is arranged in the longitudinal direction between the conical longitudinal portion 71 and the bearing portion 73. The portions 71, 72, 73 are fixedly connected to one another.

The cylindrical longitudinal portion 72 is subsequently only designated as the longitudinal portion 72 for reasons of simplicity. The longitudinal portion 72 has an opening structure 74 formed by a plurality of strut elements 75 and several transverse discs 76.

The transverse discs 76 according to FIGS. 2 and 3 have a central passage opening 76′. It may be well recognized in FIGS. 2 and 3 that the opening structure 75 has a plurality of openings 77 for the passage of a medium to be clarified or to be separated, in particular of a two-phase mixture or a three-phase mixture. By the openings 77, an interior space 79 of the longitudinal portion 72 is in the installed state of the screw hub 70 in fluid connection with an interior drum space that is not illustrated. The openings 77 are formed between the strut elements 75.

The longitudinal portion 72 is formed, in particular composed, of several axially arranged strut segments 80. The strut segments 80 comprise in this case several of the strut elements 75 and several of the openings 77, which are delimited by the strut elements 75 and at least one transverse disc 76. The transverse discs 76 are provided for axially connecting the individual strut segments 80. Furthermore, the transverse discs 76 serve for stabilizing the longitudinal portion 72.

The strut elements 75 are arranged radially outside relative to the longitudinal axis of the screw hub 70 such that the strut elements 75 form a circumference of the longitudinal portion 72. The strut elements 75 are respectively combined into strut pairs 81. In other words, two strut elements 75 respectively form a strut pair 81. The respective strut segment 80 thus has several strut pairs 81. The strut pairs 81 are arranged evenly distributed in the circumferential direction. In this case, the strut pairs 81 are arranged alternatingly turned by about 180 degrees. Specifically, two adjacent strut pairs 81 are respectively arranged to be turned by about 180 degrees.

According to FIGS. 2 and 3, the two strut elements 75 of the respective strut pair 81 extend in the longitudinal direction and transversely to the longitudinal direction of the screw hub 70. In other words, the two strut elements 75 of the strut pair 81 are arranged obliquely relative to the longitudinal axis of the screw hub 70. The strut elements 75 converge towards one another in the longitudinal direction at a first end 82 of the strut pair 81. At a second end 83 of the strut pair 81, the two strut elements 74 are spaced from one another in the transverse direction, in particular in the circumferential direction. Substantially, the strut pair 81 is formed to be triangular.

In the screw hub 70 according to FIG. 2, the strut pairs 81 of the single strut segments 80 are arranged at the intermediate transverse disc 76 to be axially directly opposite. In this case, the first ends 82 each are arranged to be axially directly opposite to the respective transverse disc 76, or the second ends 83 each are arranged to be axially directly opposite to the transverse disc 76. In the longitudinal direction of the longitudinal portion 72, the strut pairs 81 of the strut segments 80 are arranged to be turned, in particular by 180 degrees, in an oppositely alternating manner.

According to FIG. 2, the strut elements 75 respectively are formed by separate longitudinal bars 91, which are in contact at the first end 82 of the strut pair 81. The strut elements 75 of the strut pairs 81 are interconnected at the first end 82. The two strut elements 75 may be interconnected in a substance-fit and/or force-fit connection. The two strut elements 81 may be interconnected by welding and/or screwing.

The opening 77 is delimited by the strut elements 75 in the region of the first end 82 of the strut pair 81. The first end 82 forms a pointed end of the strut pair 81. At the opposite, second end 83 of the strut pair 81, the opening 77 is delimited by the transverse disc 76. The strut pair 81 according to FIG. 2 this is formed to be open towards the transverse disc 76. In other words, the strut pair 81 encloses the opening only partially.

As indicated in FIG. 2, the strut elements 75 of the respective strut pair 81 have a circular cross-section. It is also possible for the strut elements 75 to have alternatively an angular, in particular square, triangular or trapezoidal and/or an oval cross-section.

In contrast to the screw hub 70 according to FIG. 2, the screw hub 70 according to FIG. 3 has strut pairs 81 formed by strut elements 75 being formed in one piece with one another. Subsequently, the screw hub 70 according to the invention will be described in more detail by means of FIGS. 3 to 6d.

The strut pairs 81 of the longitudinal portion 72 of the screw hub 70 according to FIG. 3 form a closed volume body or a closed contour completely enclosing the opening 77. The strut pairs 81 are formed by casting, in particular precision casting. In other words, the strut pairs 81 are made of one piece. Alternatively, the strut pairs 81 may also be formed by a cutting process.

The strut pairs 81 are formed to be triangular. The respective strut pair 81 has two front-side connecting areas 84, 85 interconnecting the two strut elements 75 of the strut pair 81 in a substance-fit manner. In this case, a first front-side connecting area 84 is formed at the first, in particular pointed end 82 of the strut pair 81, and a second front-side connecting area 85 is formed at the second, in particular broad end 83 of the strut pair 81. The connecting areas 84, 85 connect the strut elements 75 transversely to the longitudinal axis of the screw hub 70. The connecting areas 84, 85 have an application surface 84′, 85′ at the respective front side for being applied to the transverse discs 76. The connecting areas 84, 85 can be seen well in FIGS. 4 and 5.

It is shown according to FIGS. 4 and 5 that the first connecting area 84 has a single passage opening 86 and the second connecting area 85 has two passage openings 86. The passage openings 86 are formed in the longitudinal direction of the screw hub 70. The passage openings 86 each are formed by a bore. The respective strut pair 81 is connected to the respectively adjacent transverse disc 76 by fastening means, in particular screws and/or bolts. Alternatively, or additionally, the respective strut pair 81 may be connected to the adjacent transverse disc 76 in a substance-fit manner, for example, by welding.

The respective strut pair 81 has an inner side 87 and an outer side 88. The inner side 87 is facing towards the longitudinal axis of the screw hub 70. The outer side 88 is facing away from the screw hub 70 or, in an installation situation, is facing towards an interior drum surface. In other words, the inner side 87 is formed radially inside on the strut pair 81, and the outer side 88 is formed radially outside on the strut pair 81. The two sides 87, 88 are formed to be opposite to one another on the strut pair 81.

FIG. 4 shows a perspective top view of the strut pair 81 of the screw hub according to FIG. 3. In this case, the outer side 88 of the strut pair 81 can be seen in FIG. 4. The outer side 88 has a surface 88′ for applying a screw spiral coil. The surface 88′ forms a part of the circumference of the longitudinal portion 72. The surface 88′ is greater than a surface 87′ of the inner side 87 of the strut pair 81, as can be seen in FIG. 5. A circumferential curve towards the opening 77 is in each case formed at the inner side 87 and the outer side 88. The curves each have different radii 89, 90.

The radius 89 of the inner side 87 is greater than the radius 90 of the outer side 88. In other words, the curve on the inner side 87 is formed to be greater towards the opening 77 than the curve on the outer side 88. The inner side 87 and the outer side 88 are circumferentially rounded towards the opening 77. In other words, the radius 89 of the inner side 87 and the radius 90 of the outer side 88 are formed to be circumferential to the opening 77. As can be recognized in FIGS. 4 to 6d, the strut pair 81 on the strut elements 75 also has a radius or curve at the side facing away from the opening 77.

As can be recognized well in FIGS. 6a to 6d, the inner side 87 and the outer side 88 of the respective strut pair 81 are formed to be convex. In other words, the inner side 87 and the outer side 88 are arched. Alternatively, or additionally, it is also possible for the inner side 87 and the outer side 88 to be formed to be flat at least in some sections.

In FIGS. 6a to 6d, cross-sections of the strut pair 81 of the kind described above are shown in different longitudinal positions of the strut pair 81.

FIGS. 6a and 6d show a cross-section of the strut pair 81 in each case in a different longitudinal position of the strut elements 75, wherein the cross-sections are arranged between the two connection areas 84, 85. It can be seen in this case that the two strut elements 75 of the strut pair 81 each have a cross-section 92 being of mirror symmetry. The cross-sections 92 of the two strut elements 75 have a cross-sectional surface of equal size. The respective cross-section 92 of the two strut elements 75 is substantially constant between the two connecting areas 84, 85.

The respective cross-section 92 is circular in some sections and straight-lined in some sections. Alternatively, the cross-section 92 can be formed to be angular, in particular square, triangular or trapezoidal, and/or oval. FIGS. 6c and 6d show the transition of the strut elements 75 into the first connecting area 84 as well as the cross-sectional change associated therewith.

FIGS. 7 to 10 show a cylindrical longitudinal portion 72 of a screw hub 70 of a further exemplary embodiment according to the invention, which hereinafter will be explained in more detail.

The longitudinal portion 72 extends along a longitudinal axis and is formed by a tube 93. The tube 93 has a plurality of openings 94 for the passage of a medium, in particular a two-phase mixture or a three-phase mixture. The openings 94 are formed within the tube wall 95 and respectively form a free passage. The openings 94 each have a clear length 96, which is greater than a clear width 97 of the respective opening 94. In other words, the length of the opening 94 is greater than the width of the opening 94. The clear length 96 of the openings 94 extends in the longitudinal direction, in particular in parallel to the longitudinal axis, and the clear width 97 extends transversely to the longitudinal direction.

As can be seen in FIGS. 7 to 9, the openings 94 are formed in the circumferential direction to be helically distributed within the tube wall 95. In each case two openings 94 are spaced from one another in the circumferential direction. The distance between the two openings 94 in the circumferential direction is smaller than the clear width 97 and the clear length 96 of the openings 94. In other words, the distance between two openings 94 in the circumferential direction is smaller than the longitudinal extension of the openings 94 and the extension of the opening 94 transversely to the longitudinal axis. The same applies for the distance between two of the openings 94 in the longitudinal direction of the longitudinal portion 72. Between each of two adjacent openings 94 in the longitudinal direction of the longitudinal portion 72, a resting surface 98 for a screw spiral coil is formed. The resting surface 98 is formed outside at the tube wall 95 and surrounds it likewise helically.

According to FIG. 8 and specifically in the detail view according to FIG. 10, it can be recognized that the openings 94 are formed to have the shape of a rhombus. The openings 94 may be formed to be square, or to be circular at least in some sections. The openings 94 are formed to be rounded in corner areas. In other words, the openings 94 have radii in the corner areas. The openings 94 are equally shaped, i.e., the openings 94 have an equal passage shape. In the illustrated example, the openings 94 each have a parallelogram-like shape. In each case, two sides opposite to one another thus are formed to be parallel and of equal length.

It is also possible for the openings 94 to differ from one another in their shapes. FIG. 9 shows a cross-section through the tube 93.

### LIST OF REFERENCE NUMERALS

10 solid bowl screw centrifuge
12 longitudinal axis
14 outer housing
16 drum
18 first drum bearing
20 second drum bearing
22 inlet for the product/medium to be clarified
24 outlet for the heavy phase
26 outlet for the light phase
28 drive
30 centrifuge screw
32 screw hub
34 screw spiral coil
36 cylindrical longitudinal portion
38 conical portion
40 first screw bearing
42 second screw bearing
44 closed shell surface
46 inlet tube
48 inlet region
52 pond depth
56 grid structure
58 longitudinal bar
60 transverse disc
70 screw hub
71 conical longitudinal portion
72 cylindrical longitudinal portion
73 bearing portion
74 opening structure
75 strut elements
76 transverse discs
76′ central passage opening
77 openings
79 interior space
80 strut segments
81 strut pair
82 first end of the strut pair
83 second end of the strut pair
84 first connecting area
84′ application surface
85 second connecting area
86 passage opening
87 inner side
87′ surface of the inner side
88 outer side
88′ surface of the outer side
89 radius of the inner side
90 radius of the outer side
91 single bars
92 cross-section of the strut element
93 tube
94 openings
96 tube wall
96 clear length
97 clear width
98 resting surface

1. A screw hub (70) for a centrifuge screw, which extends along a longitudinal axis and has at least one longitudinal portion (72) having an opening structure (74), wherein the opening structure (74) is formed by a plurality of strut elements (75) delimiting a plurality of openings (77) for the passage of a medium, wherein the strut elements (75) are arranged on the longitudinal portion (72) radially outside relative to the longitudinal axis and form a circumference of the longitudinal portion (72),
characterized in that
in each case two strut elements (75) form a strut pair (81), which delimits at least one opening (77), wherein both of the strut elements (75) of the strut pair (81) extend in the longitudinal direction and transversely to the longitudinal direction, or at least one strut element of the strut pair (81) respectively extends in the longitudinal direction, and a second strut element of the strut pair (81) extends transversely to the longitudinal direction.

2. The screw hub (70) according to claim 1,
characterized in that
the strut elements (75) of the strut pair (81) enclose the opening (77) partially or completely.

3. The screw hub (70) according to claim 1,
characterized in that
the strut elements (75) of the strut pair (81) are formed to be separated from one another, in particular as single bars (91), or to be in one piece with one another, in particular by a casting process.

4. The screw hub (70) according to claim 1,
characterized in that
the strut elements (75) are arranged such that the strut pair (81) is formed in the shape of a triangle.

5. The screw hub (70) according to claim 1,
characterized in that
the strut pair (81) comprises an inner side (87) and an outer side (88) each having a radius (89, 90) towards the opening (77), wherein the radius (89) of the inner side (87) is greater than the radius (90) of the outer side (88).

6. The screw hub (70) according to claim 5,
characterized in that
the strut pair (81) has a surface (87′, 88′) on the inner side (87) and on the outer side (88), respectively, wherein the surface (88′) on the outer side (88) is greater than the surface (87′) on the inner side.

7. The screw hub (70) according to claim 5,
characterized in that
the inner side (87) and/or the outer side (88) of the strut pair (81) are/is formed to be arched, in particular curved, and/or flat.

8. The screw hub (70) according to claim 1,
characterized in that
the strut pair (81) has at least two front-side connecting areas (84, 85) by means of which the strut elements (75) are connected to one another in a substance-fit manner.

9. The screw hub (70) according to claim 8,
characterized in that
the connecting areas (84, 85) each have at least one passage opening (86), by means of which the strut pair (81) is connected to at least one hub element (71, 72, 73), in particular a transverse disc (76), a bearing bush (73) or a screw cone (71), or to a further strut pair (81).

10. The screw hub (70) according to claim 9,
characterized in that
the strut pairs (81) are connected to the hub element (71, 73, 76), in particular a transverse disc (76), a bearing bush (73) or a screw cone (71), or to a further strut pair (81) in a substance-fit and/or force-fit manner.

11. The screw hub (70) according to claim 8,
characterized in that
the strut elements (75) of the strut pair (81) each have a cross-section (92) between the two connecting areas (84, 85), which is substantially constant along the longitudinal direction of the strut elements (75).

12. The screw hub (70) according to claim 1,
characterized in that
the longitudinal portion (72) has at least one strut segment formed by several strut pairs (81) interconnected in the longitudinal direction of the screw hub (70) and/or transversely to the longitudinal direction.

13. The screw hub (70) according to claim 12,
characterized in that
the longitudinal portion (72) has several of the strut segments (80) arranged along the longitudinal axis and being connected to one another by intermediate transverse discs (76), wherein the strut pairs (81) of the strut segments (80) being coupled to the transverse discs (76).

14. The screw hub (70) according to claim 12,
characterized in that
the strut pairs (81) of the strut segment (80) are arranged evenly distributed in the circumferential direction.

15. A screw hub (70) for a centrifuge screw, which extends along a longitudinal axis and has at least one longitudinal portion (72) formed by a tube (93), in which a plurality of openings (94) is formed for the passage of a medium, wherein the openings (94) each have a longitudinal extension, which is preferably greater than a width of the respective opening (94).

16. The screw hub (70) according to claim 15,
characterized in that
the openings (94) are formed in the circumferential direction to be helically distributed and/or have a parallelogram-like shape.

17. A centrifuge screw having a screw hub (70) according to claim 1 and a screw spiral coil (34) arranged circumferentially at the screw hub (70).

18. A solid bowl screw centrifuge having a centrifuge screw according to claim 17.

19. A solid bowl screw centrifuge having a screw hub (70) according to claim 1.
